(19) United States
(12) Patent Application Publication
(10) Pub. No.: US 2015/0295609 A1
(43) Pub. Date: Oct. 15, 2015

(54) WIRELESS RECEIVER AND METHOD FOR WIRELESS RECEPTION

(71) Applicant: Realtek Semiconductor Corp., HsinChu (TW)

(72) Inventors: Chung-Yao Chang, Hsinchu County (TW); Yu-Nan Lin, Hsinchu City (TW); Der-Zheng Liu, Hsinchu County (TW); Kuang-Yu Yen, Hsinchu County (TW)

(21) Appl. No.: 14/515,509

(22) Filed: Oct. 15, 2014

(30) Foreign Application Priority Data
Apr. 15, 2014 (TW) 103113756

(51) Int. Cl. H04B 1/16

(52) U.S. Cl. CPC H04B 1/16

(57) ABSTRACT

A wireless receiver includes a radio frequency (RF) receiving unit and a baseband receiving unit. A first path of the RF receiving includes a first filter, and is arranged for receiving an input RF signal and generating a first baseband input signal; a second path is arranged for receiving the input RF signal and generating a second baseband input signal. The baseband receiving unit is arranged for receiving the first baseband input signal and the second baseband input signal to generate a baseband decoded signal. One of the first path and the second path is an in-phase path, and the other is a quadrature-phase path. When the RF receiving unit operates in a first mode, the RF receiving unit only uses the first path to receive the input RF signal.

### BACKGROUND OF THE INVENTION

1. Field of the Invention

The disclosed embodiments of the present invention relate to a wireless receiver, and more particularly, to a wireless receiver and related wireless receiving method capable of switching between a single radio frequency (RF) receiving path and a double RF receiving path.

2. Description of the Prior Art

A wireless receiver, such as a Wireless Local Area Network (WLAN) receiver, a Ling-Term Evolution (LTE) receiver, or a Worldwide Interoperability Microwave Access (WiMax) receiver, uses the in-phase path and the quadrature-phase path in the radio frequency (RF) circuit for demodulation, such as a Complementary Code Keying (CCK) or an orthogonal frequency division multiplexing (OFDM), to decode. In general, the conventional wireless receiver will reduce the power consumptions of each element in the in-phase path and the quadrature-phase path (such as the mixer, the low pass filter, or the Analog-to-Digital Converter (ADC)). However, the element design has its physical limit, and thus above method is not able to satisfy requirements for low power consumption of some products (especially the mobile devices). Thus, an innovative design for reducing the power consumption is required to solve the above-mentioned problems.

### SUMMARY OF THE INVENTION

It is therefore one of the objectives of the present invention to provide a wireless receiver and related wireless receiving method capable of switching between a single radio frequency (RF) receiving path and a double RF receiving path.

In accordance with an embodiment of the present invention, an exemplary wireless receiver for receiving an input RF signal and outputting a baseband decoded signal is disclosed. The wireless receiver comprises: a RF receiving unit and a baseband receiving unit, wherein the RF receiving unit comprises: a first path and a second path. The first path is utilized for receiving the input RF signal and generating a first baseband input signal, the first path comprising a first filter, wherein a bandwidth of the first filter is broader than a bandwidth of a packet of the input RF signal. The second path is utilized for receiving the input RF signal and generating a second baseband input signal. The baseband receiving unit is utilized for receiving the first baseband input signal and the second baseband input signal to generate the baseband decoded signal, wherein one of the first path and the second path is an in-phase path, and the other one of the first path and the second path is a quadrature-phase path. When the RF receiving unit operates in a first mode, the RF receiving unit only uses the first path to receive the input RF signal.

In accordance with an embodiment of the present invention, an exemplary wireless receiving method for receiving an input radio frequency (RF) signal and outputting a baseband decoded signal is disclosed. The wireless receiving method comprises: utilizing a first path in a RF receiving unit to receive the input RF signal and generate a first baseband input signal, wherein the first path comprises a first filter and a bandwidth of the first filter is broader than a bandwidth of a packet of the input RF signal; utilizing a second path in a RF receiving unit to receive the input RF signal and generate a second baseband input signal; and utilizing a baseband receiving unit to receive the first baseband input signal and the second baseband input signal to generate the baseband decoded signal; wherein one of the first path and the second path is an in-phase path, and the other one of the first path and the second path is a quadrature-phase path; when the RF receiving unit operates in a first mode, the RF receiving unit only uses the first path to receive the input RF signal.

Briefly summarized, the embodiments of the present invention can reduce power consumption of the receiver in an idle status to reduce the whole power consumption. Besides, the present invention can reduce power consumption of the receiver in all time in a situation of a receiving condition being not bad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a wireless receiver according to an embodiment of the present invention.

FIG. 2 shows a diagram illustrating even symmetric effect of positive and negative frequency in the first mode.

FIG. 3 shows the power consumptions of the main elements in the different condition.

FIG. 4 shows the power consumptions of the main elements in the different examples.

FIG. 5 is a flowchart showing a wireless receiving method in accordance with an exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

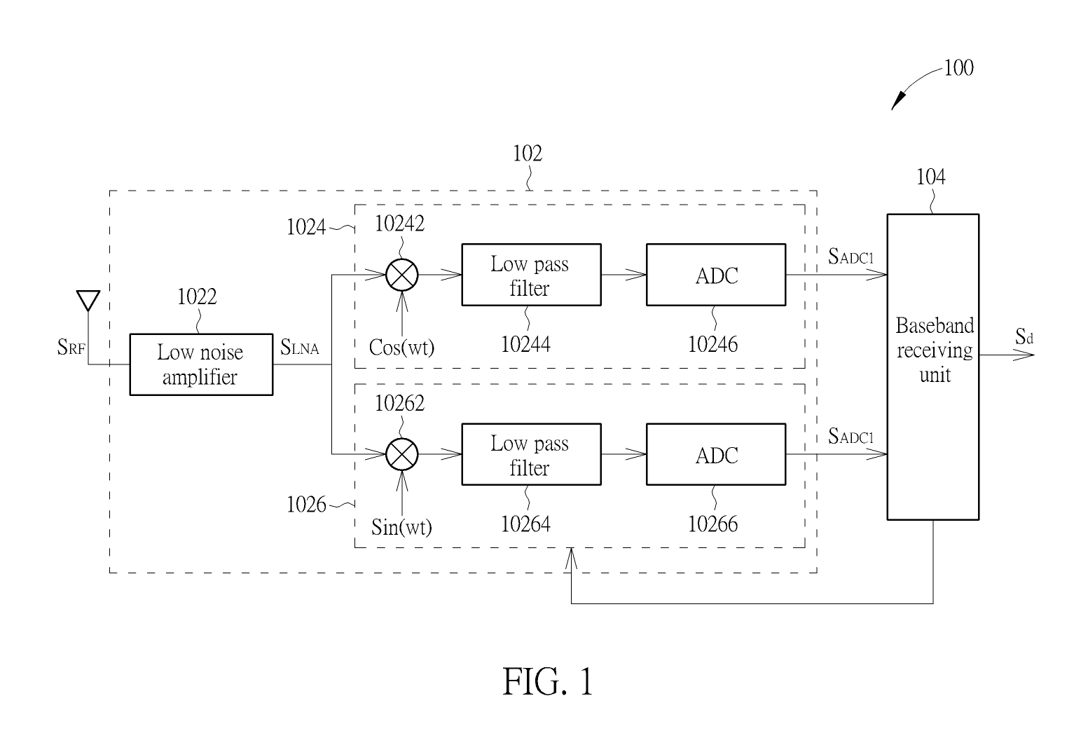

Please refer to FIG. 1. FIG. 1 is a block diagram illustrating a wireless receiver 100 according to an embodiment of the present invention. The wireless receiver 100 is utilized for receiving an input radio frequency (RF) signal S_{RF} and outputting a baseband decoded signal S_{d}, wherein the input RF signal S_{RF} adopts an Orthogonal Frequency Division Multiplexing (OFDM), and the wireless receiver 100 can demodulate for OFDM. Please note that the wireless receiver 100 is not limited to OFDM, but also can be applied to other system (such as a Complementary Code Keying (CCK) modulation system). The wireless receiver 100 comprises: a RF receiving unit 102 and a baseband receiving unit 104, wherein the RF receiving unit 102 is utilized for receiving the input RF signal S_{RF} and converting it to the digital domain and transmitting it to the baseband receiving unit 104. The RF receiving unit 102 comprises a low noise amplifier 1022, an in-phase path 1024, and a quadrature-phase path 1026.

After the input RF signal S_{RF} passes by the low noise amplifier 1022, an amplified signal S_{LNAn i}s generated, and enters into the in-phase path 1024 and the quadrature-phase path 1026, respectively. The in-phase path 1024 is utilized for receiving the amplified signal S_{LNA} and generates a first baseband input signal S_{ANC1}, wherein the in-phase path 1024 comprises a first mixer 10242, a first low pass filter 10244, and a first analog-to-digital converter (ADC) 10246. The quadrature-phase path 1026 is utilized for receiving the input RF signal S_{SNA} and generates a second baseband input signal S_{ADC2} wherein the quadrature-phase path 1026 comprises a second mixer 10262, a second low pass filter 10264, and a second ADC 10266. The first low pass filter 10244 and the second low pass filter 10264 are utilized for performing low pass filtering process for signals extracted by the first mixer 10242 and the second mixer 10262 from high frequency carrier waves, respectively, and the signals are converted from the analog domain to the digital domain by the first ADC 10246 and the second ADC 10266, respectively. The baseband receiving unit 104 is utilized for performing a further signal process (such as a Carrier Frequency Offset (CFO) compensation) for the first baseband input signal S_{ADC1} and the second baseband input signal S_{ADC2} in the analog domain. However, this is only for an illustrative purpose and is not meant to be a limitation of the present invention. In any case, various design modifications and alterations of the in-phase path and the quadrature-phase path should fall into the disclosed scope of the present invention as long as the design modifications and alterations are on the basis of the same spirit or can generate similar effects.

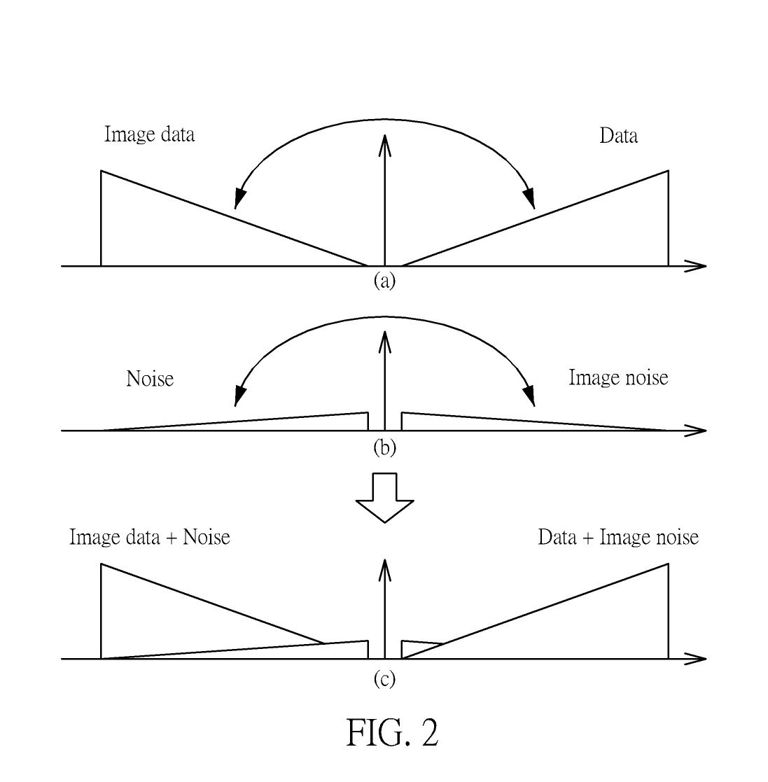

In this embodiment, the wireless receiver 100 has a first mode and a second mode. In the first mode, only the in-phase path 1024 is turned on, and in the second mode, the in-phase path 1024 and the quadrature-phase path 1026 are turned on in the same time. However, please note that the wireless receiver 100 in this embodiment is not limited to only turn on the in-phase path 1024, but also can only turn on the quadrature-phase path 1026. Specifically, when the RF receiving unit 102 operates in the first mode to receive a wireless packet of the input RF signal S_{LNA}, a bandwidth of the in-phase path 1024 is twice broader (or over twice broader) than a bandwidth of the wireless packet. In other words, the twice broader bandwidth is utilized for compensating the absent information of turning off the quadrature-phase path 1026. For example, if a bandwidth of the wireless packet is 20M, then a bandwidth of the in-phase path 1024 is required to be increased to at least 40M including at least two sub-channels of 20M. Due to the even symmetric effect of positive and negative frequency, increasing the bandwidth will receive the signals and image signals in the same time. Thus, a driver in the up layer has to inform the baseband receiving unit 104 the sub-channel where the packet is in. After the baseband receiving unit 104 receives the data of the whole 40M bandwidth, only the sub-channel where the packet is in is required to be decoded. Besides, the above process will also get image noise to the signals going to be received. Please refer to FIG. 2. FIG. 2 shows a diagram illustrating even symmetric effect of positive and negative frequency in the first mode. When the in-phase path 1024 is turned off, a data in the right side in FIG. 2(a) is in a first sub-channel having a bandwidth of 20M, and an image data of even symmetric will be generated in the left side in FIG. 2(a). On the contrary, a noise in the left side in FIG. 2(b) will generate an image noise of even symmetric in the first sub-channel where the data is. The right side in FIG. 2(c) is a result of adding the data and the image data. Thus, although the first mode saves more power than the second mode, the second mode may have a worse signal quality.

Thus, a conservative mixing scheme is adopted in this embodiment, that is, the first mode is adopted in a part of the time, and the second mode is adopted in the rest of the time. For example, when the wireless receiver 100 is in an idle status, the RF receiving unit 102 maintains in the first mode to save power. When a packet is detected, the wireless receiver 100 will enter into a packet receiving status, and the baseband receiving unit 104 will generate a control signal S_{c} to turn on the quadrature-phase path 1026, so as to switch the RF receiving unit 102 of the wireless receiver 100 from the first mode to the second mode to increase receiving ability. For example, the control signal S_{c} is via a Low-Speed Serial Interface (LSSI), a High-Speed Serial Interface (HSSI), or a direct-write control to turn on the quadrature-phase path 1026, and when the wireless receiver 100 switches back to the idle status, the control signal S_{c} will turn off the quadrature-phase path 1026 to switchback to the first mode. In detail, the Automatic Gain Control (AGC) time of the training sequence in the initial time of receiving packets can be utilized for performing transient convergence after turning on the quadrature-phase path 1026. That is, in the AGC time defined in the spec, it is practical to only use the information of the in-phase path 1024 to perform the AGC to adjust signals until the AGC time is over. In the same time, after the quadrature-phase path 1026 is turned on, the in-phase path 1024 and the quadrature-phase path 1026 can be utilized normally for performing the demodulation together. However, please note that the mode switching of the wireless receiver 100 in the above embodiment is only for an illustrative purpose and is not meant to be a limitation of the present invention. For example, only switch to the second mode when the signal quality is not good, otherwise, maintain in the first mode.

In addition, the OFDM is more sensitive to the Inter-Carrier Interference (ICI) generated by the carrier frequency offset. In other words, when the carrier frequency offset is bigger, the corresponding ICI is more serious, and further affects the receiving quality of the OFDM. In general, a carrier frequency offset estimation will be performed in the receiving terminal of the OFDM and a compensation is performed. That is, utilize the Auto-Correlation technology to get the phase in the time domain, and make a calculation for the phase to obtain a real carrier frequency offset estimation value and perform the compensation. However, in a part of the time in the embodiment, only the in-phase path 1024 is turned on, and it is not able to get the phase in the time domain. Thus, for example, the carrier frequency offset estimation can be performed in the frequency domain. Or, perform a frequency tracing in the system level first, after the frequency tracing is stable and the carrier frequency offset is lowered to a certain level, allow the wireless receiver 100 to switch to the first mode to save power.

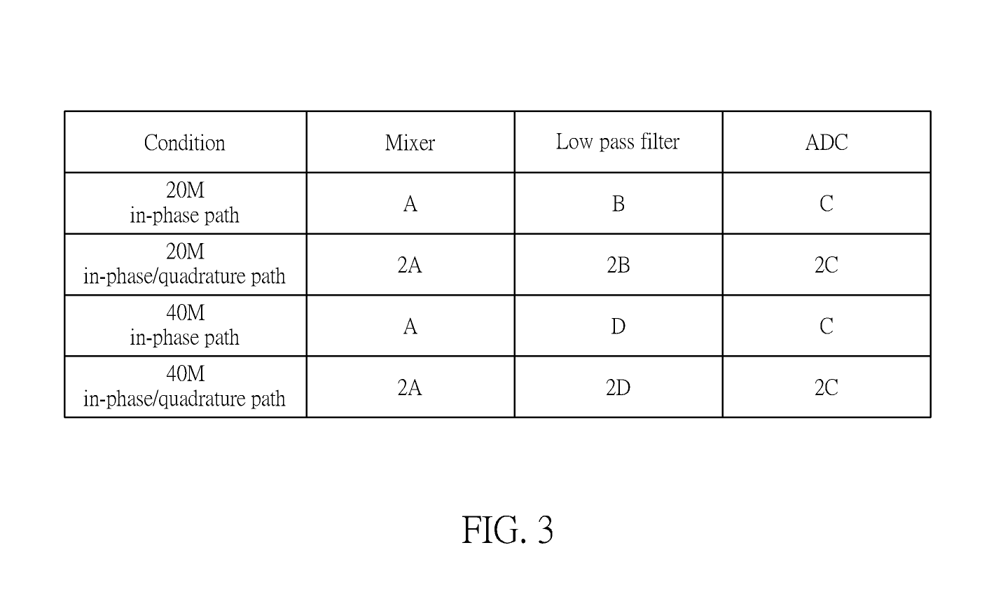

Please refer to FIG. 3. FIG. 3 shows the power consumptions of the main elements in the different condition. The elements comprise the mixer, the low pass filter, and the ADC. The power consumptions of the different elements in the different condition are represented by A, B, C, D, wherein A, B, C, D are real number bigger than 0. The 20M in-phase path represents only the in-phase path is turned on, and the bandwidth of the in-phase path is 20M. The 20M in-phase/quadrature-phase path represents the in-phase path and the quadrature-phase path are turned on in the same time, and the bandwidths of the in-phase path and the quadrature-phase path are both 20M. The 40M in-phase path represents only the in-phase path is turned on, and the bandwidth of the in-phase path is 40M. The 40M in-phase/quadrature-phase path represents the in-phase path and the quadrature-phase path are turned on in the same time, and the bandwidths of the in-phase path and the quadrature-phase path are both 40M. The power consumption of the prior art is the power consumption of the 20M in-phase/quadrature-phase path (i.e. 2A+2B+2C). The power consumption of the first mode in the present invention is the power consumption of the 40M in-phase path (i.e. A+D+C), and the power consumption of the second mode in the present invention is the power consumption of 40M in-phase/quadrature-phase path (i.e. 2A+2D+2C). Thus, when the below formula is found, it means the power consumption of the first mode in the present invention is lower than that of the prior art.

A+D+C<2A+2B+2C (1)

That is,

D−2B<A+C (2)

Thus, as long as the increasing quantity of the power consumption of the low pass filter in the 40M in-phase path compared with the power consumption of the low pass filter in the 20M in-phase/quadrature-phase path is lower than the power consumption of the mixer and the ADC, the power consumption of the first mode in the present invention is lower than that of the prior art. In general, when the low pass filter has twice bigger the bandwidth, the power consumption of it is not twice higher, but only 1.2 or 1.3 times higher, and thus the below formula can be obtained via the empirical law.

B<D<2B (3)

From formula (2) and formula (3), as long as A+C is higher or equal to 0, the formula (1) will be found.

Next, add the second mode to operate together. If a ratio of the first mode in all operation is K (for example, a ratio of the idle status in all operation is K), and a ratio of the second mode in all operation is (1−K) (for example, a ratio of the receiving status in all operation is 1−K), and then the whole power consumption is K(A+D+C)+(1−K)(2A+2D+2C). Thus, when the below formula is found, it means the power consumption of mixing the first mode and the second mode in the present invention is lower than that of the prior art.

K(A+D+C)+(1−K)(2A+2D+2C)<2A+2B+2C (4)

That is,

K>2(D−B)/(A+C+D) (5)

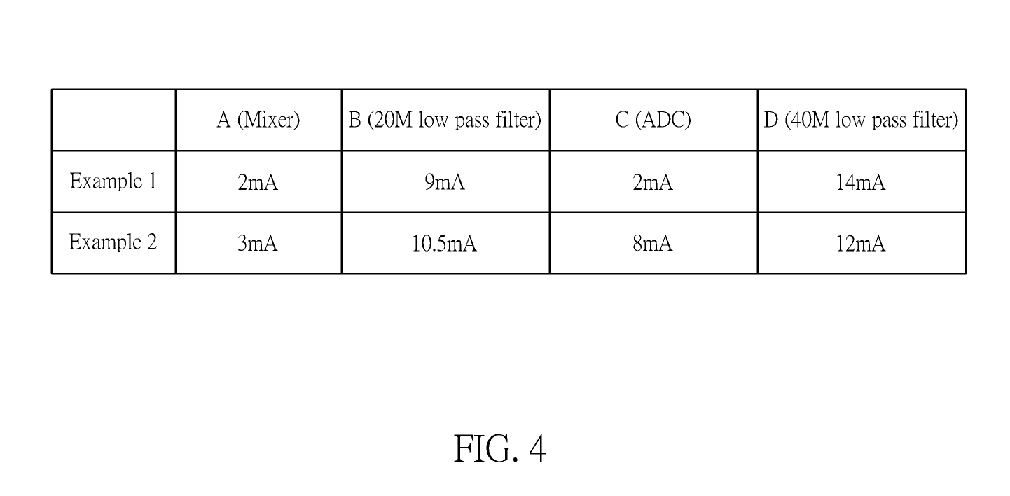

Thus, as long as the formula (5) is found, it means the power consumption of mixing the first mode and the second mode in the present invention is lower than that of the prior art. Please refer to FIG. 4. FIG. 4 shows the power consumptions of the main elements in the different examples. Taking the example 1 for example, the ratio K of the second mode in all operation is required to be 5/9 (˜0.56) or more. Taking the example 2 for example, the ratio K is only required to be 3/23 (˜0.13) or more. In general, the wireless receiver (such as a wireless LAN receiver, an LTE receiver, or a WiMax receiver) in the practical applications, the time in the idle status is often longer than in the receiving status. Thus, using the first mode in the idle status and using the second mode in the receiving status can save more power consumption than the prior art.

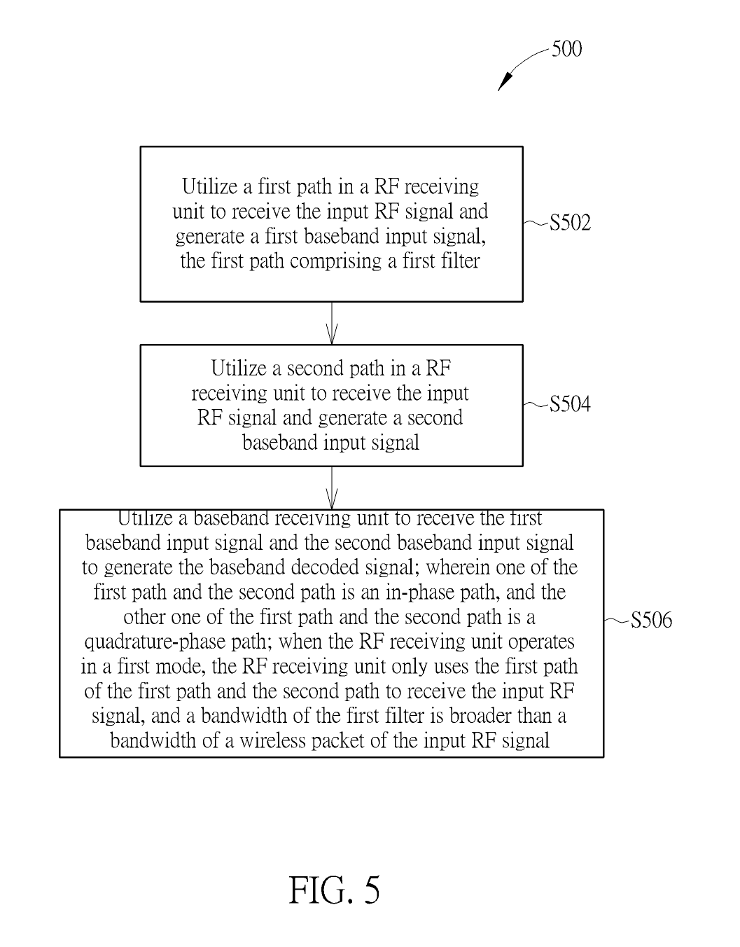

Please refer to FIG. 5. FIG. 5 is a flowchart showing a wireless receiving method 500 in accordance with an exemplary embodiment of the present invention, wherein the wireless receiving method 500 is utilized for receiving an input radio frequency (RF) signal and outputting a baseband decoded signal. Provided that the result is substantially the same, the steps in FIG. 5 are not required to be executed in the exact order of flowchart shown in FIG. 5. Moreover, some steps in FIG. 5 can be omitted according to different embodiments or design requirements. The wireless receiving method 500 disclosed by the present invention comprises the following steps:

Step S502: Utilize a first path in a RF receiving unit to receive the input RF signal and generate a first baseband input signal, the first path comprising a first filter;

Step S504: Utilize a second path in a RF receiving unit to receive the input RF signal and generate a second baseband input signal;

Step S506: Utilize a baseband receiving unit to receive the first baseband input signal and the second baseband input signal to generate the baseband decoded signal; wherein one of the first path and the second path is an in-phase path, and the other one of the first path and the second path is a quadrature-phase path; when the RF receiving unit operates in a first mode, the RF receiving unit only uses the first path of the first path and the second path to receive the input RF signal, and a bandwidth of the first filter is broader than a bandwidth of a wireless packet of the input RF signal.

The steps 502-506 of the wireless receiving method 500 should be clearly understood by those of average skill in this art after reading the operational details and configuration details for FIGS. 1-4, and thus further explanation of the details and operations for the steps 502-514 of the wireless receiving method 500 are omitted herein for the sake of brevity.

Briefly summarized, the embodiments of the present invention can reduce power consumption of the receiver in an idle status to reduce the whole power consumption. Besides, the present invention can reduce power consumption of the receiver in all time in a situation of a receiving condition being not bad.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless receiver, for receiving an input radio frequency (RF) signal and outputting a baseband decoded signal, comprising:
a RF receiving unit, comprising:
A first path, for receiving the input RF signal and generating a first baseband input signal, the first path comprising a first filter, wherein a bandwidth of the first filter is broader than a bandwidth of a packet of the input RF signal; and
a second path, for receiving the input RF signal and generating a second baseband input signal; and
a baseband receiving unit, for receiving the first baseband input signal and the second baseband input signal to generate the baseband decoded signal;
wherein one of the first path and the second path is an in-phase path, and the other one of the first path and the second path is a quadrature-phase path;
when the RF receiving unit operates in a first mode, the RF receiving unit only uses the first path to receive the input RF signal.

2. The wireless receiver of claim 1, wherein the bandwidth of the first filter is at least twice broader than a bandwidth of the packet of the input RF signal, and the bandwidth of the first filter covers a plurality of sub-channels, wherein one of the plurality of sub-channels is utilized for receiving the packet of the input RF signal.

3. The wireless receiver of claim 1, wherein when the wireless receiver is in an idle status, the RF receiving unit operates in the first mode.

4. The wireless receiver of claim 1, wherein when the RF receiving unit operates in a second mode, the RF receiving unit uses the first path and the second path to receive the input RF signal.

5. The wireless receiver of claim 4, wherein the second path comprises a second filter, and a bandwidth of the second filter is broader than the bandwidth of the packet of the input RF signal.

6. The wireless receiver of claim 4, wherein when the wireless receiver is in an idle status, the RF receiving unit operates in the first mode; and wherein when the wireless receiver is in a packet receiving status, the RF receiving unit operates in the second mode.

7. The wireless receiver of claim 4, wherein the wireless receiver determines whether the input RF signal is detected or not, and the RF receiving unit switches to the second mode according to the determined result.

8. The wireless receiver of claim 4, wherein the RF receiving unit receives a control signal generated by the baseband receiving unit via one of a Low-Speed Serial Interface (LSSI), a High-Speed Serial Interface (HSSI), and a direct-write control, and switches between the first mode and the second mode according to the control signal.

9. The wireless receiver of claim 4, wherein the wireless receiver performs a Carrier Frequency Offset (CFO) compensation in the second mode.

10. The wireless receiver of claim 1, wherein the input RF signal is modulated by a Complementary Code Keying (CCK) modulation.

11. The wireless receiver of claim 1, wherein the input RF signal is processed by an Orthogonal Frequency Division Multiplexing (OFDM).

12. A wireless receiving method, for receiving an input radio frequency (RF) signal and outputting a baseband decoded signal, comprising:
utilizing a first path in a RF receiving unit to receive the input RF signal and generate a first baseband input signal, wherein the first path comprises a first filter and a bandwidth of the first filter is broader than a bandwidth of a packet of the input RF signal;
utilizing a second path in a RF receiving unit to receive the input RF signal and generate a second baseband input signal; and
utilizing a baseband receiving unit to receive the first baseband input signal and the second baseband input signal to generate the baseband decoded signal;
wherein one of the first path and the second path is an in-phase path, and the other one of the first path and the second path is a quadrature-phase path; when the RF receiving unit operates in a first mode, the RF receiving unit only uses the first path to receive the input RF signal.

13. The wireless receiving method of claim 12, wherein the bandwidth of the first filter is at least twice broader than a bandwidth of the packet of the input RF signal, and the bandwidth of the first filter covers a plurality of sub-channels, wherein one of the plurality of sub-channels is utilized for receiving the packet of the input RF signal.

14. The wireless receiving method of claim 12, wherein when the wireless receiver is in an idle status, the RF receiving unit operates in the first mode.

15. The wireless receiving method of claim 12, wherein when the RF receiving unit operates in a second mode, the RF receiving unit uses the first path and the second path in the same time to receive the input RF signal.

16. The wireless receiving method of claim 15, wherein the second path comprises a second filter; and a bandwidth of the second filter is broader than the bandwidth of the packet of the input RF signal.

17. The wireless receiving method of claim 15, wherein when the wireless receiver is in an idle status, the RF receiving unit operates in the first mode; and when the wireless receiver is in a packet receiving status, the RF receiving unit operates in the second mode.

18. The wireless receiving method of claim 15, wherein the RF receiving unit receives a control signal generated by the baseband receiving unit via one of a Low-Speed Serial Interface (LSSI), a High-Speed Serial Interface (HSSI), and a direct-write control, and switches between the first mode and the second mode according to the control signal.

19. The wireless receiving method of claim 15, wherein the wireless receiver performs a Carrier Frequency Offset (CFO) compensation in the second mode.

20. The wireless receiving method of claim 12, wherein the input RF signal is processed by a Complementary Code Keying (CCK) modulation or an Orthogonal Frequency Division Multiplexing (OFDM).
